(19) United States
(12) Patent Application Publication
(10) Pub. No.: US 2015/0004864 A1
(43) Pub. Date: Jan. 1, 2015

(54) METHOD FOR CONTINUOUSLY PRODUCING A SANDWICH COMPOSITE ELEMENTS

(71) Applicant: Bayer Intellectual Property GmbH, 40789 Monheim (DE)

(72) Inventors: Rolf Roers, Odenthal (DE); Walter Schindler, Burscheid (DE); Ingo Kellerhof, Neunkirchen-Seelsheid (DE)

(21) Appl. No.: 14/374,682

(22) PCT Filed: Jan. 30, 2013
(86) PCT No.: PCT/EP13/51751

§ 371 Date: Jul. 25, 2014

(30) Foreign Application Priority Data
Feb. 2, 2012 (EP) 12153613.0

(51) Int. Cl. B29C 44/32; B32B 37/24; B32B 17/06; B32B 5/20; B32B 15/14; B32B 7/04; B32B 27/12

(52) U.S. Cl. CPC B29C 44/326; B32B 7/04; B32B 37/24; B32B 27/12; B32B 5/20; B32B 15/14; B32B 17/061; B32B 2305/022; B32B 2250/40; B32B 2305/188; B32B 2305/20; B32B 2305/28; B32B 2250/04; B32B 2311/24; B32B 2311/30; B32B 2255/02; B32B 2255/26; B32B 2260/021; B32B 2262/101; B32B 2266/0278; B32B 2307/3065
USPC 442/222; 156/79; 442/221; 442/224; 442/370; 442/373; 442/371

(57) ABSTRACT

In order to provide sandwich composite elements (100) having an improved fire protection behavior, the invention relates to a method for continuously producing sandwich composite elements (100) having a lower cover layer (10), an upper cover layer (11), and a polyurethane hard-foam core body (12) introduced between the cover layers (10, 11), wherein a double belt conveyor system (18) having a lower conveyor belt (19) and an upper conveyor belt (20) is provided and wherein the lower cover layer (10) and the upper cover layer (11) continuously run in between the conveyor belts (19, 20), wherein at least one glass-fiber mat (13) continuously runs in between the cover layers (10, 11) and is arranged adjacent to the inside or at least one of the cover layers (10, 11) and wherein a subsequently foaming reaction mixture (14) is applied to at least one inside of the cover Layers (10, 11) and/or to the glass fiber mat (13) in order to form the polyurethane hard-foam core body (12).

The invention relates to a continuous process for the production of sandwich composite elements comprising a lower outer layer, an upper outer layer, and a rigid polyurethane foam core arranged between the outer layers.

### PRIOR ART

Sandwich composite elements with two outer layers and with a hard foam core located therebetween are subject to many different requirements, and in particular to increasingly stringent requirements in relation to ability to resist fire at low densities of the rigid polyurethane foam core, optimized smoke performance, and also efficient thermal insulation. The market is moreover demanding increasing productivity levels in the production of these sandwich composite elements, together with high surface quality of the external sides of the outer layers.

EP 0 727 550 A1 discloses sandwich composite elements with a core made of a polyurethane foam sheet and with two metallic outer layers, where there is additionally a mineral insulation layer comprising magnesium oxychloride arranged between the core layer and the metallic outer layers.

EP 0 891 860 A2 discloses sandwich composite elements with a core made of rigid foam and with two metallic outer layers, and proposes arranging, between the core material and the outer layers, a mat made of intumescent material of at least 20% by mass, said mat being composed at least to some extent of graphite. The mat has perforation in order to permit bonding between the rigid foam core and the metal outer sheets via the holes of the perforation. The use of liquid polyurethane adhesives is provided for this purpose.

EP 2 095 926 A1 discloses insulation materials made of an insulation layer made of synthetic foam and of an intumescent layer made of polyurethane foam based on phosphorus-containing polyols.

WO 2005/095 728 A1 concerns thermal insulation composites with improved thermal stability and with improved fire performance. Sandwich composite elements are disclosed in which there is a fire-protection layer located between the core layer and at least one of the metal outer sheets. Alkali metal silicates, in particular hydrated sodium silicate, expanded graphite, and expanded mica are disclosed as materials suitable for the fire-protection layer. Adhesives are required for the bonding of the constituents of the composite element.

JP 2005 163 481 A concerns the improvement of sandwich composite elements with respect to resistance to fire and thermal insulation effect. To this end, the use of an additional inorganic layer in the composite element is proposed. Calcium silicate sheets, mineral wool sheets, and gypsum plasterboard sheets are mentioned as suitable inorganic layers.

JP 2008 261 196 A likewise concerns the improvement of sandwich composite elements in respect of resistance to fire and of thermal insulation effect. The composite elements comprise a core layer made of polyurethane, mineral wool, glass wool, or carbon fibers, and also outer layers made of steel or of an inorganic material. An impregnation step is additionally proposed for the surface of the core layer, using a water-soluble fire-resistant material such as a silicate.

WO 2008/113751 A1 discloses a batch process for the production of sandwich composite elements made of polyurethane, where a core layer and a reinforcing fiber layer are provided and a polyurethane reaction mixture is applied to the reinforcing fiber layer, and the resultant part is hardened in a mold. A polyurethane reaction mixture is used here which comprises a reactive chain extender having at least two groups reactive toward isocyanates, of which at least one group is an NH₂ group. Preferred core layers are thermoformable polyurethane foams, and also paper honeycombs, metal honeycombs, or plastics honeycombs. Possible reinforcing fiber layers disclosed are glassfiber mats, glassfiber nonwovens, random glassfiber layers, woven glassfiber fabrics, chopped or ground glass fibers or chopped or ground mineral fibers, natural-fiber mats and knitted natural-fiber fabrics, chopped natural fibers and fiber mats, fiber nonwovens, and knitted fiber fabrics based on polymer fibers, on carbon fibers, or on aramid fibers, and also mixtures of these.

DE 195 06 255 A1 describes sandwich composite elements with outer layers made of solid polyurethane, and polyurethane foam layers as core, where at least the solid polyurethane layers comprise from 15 to 55% by weight of mica, with the aim by way of example of advantageous production of sanitary products. It is stated here that the use of mica in the reactive polyurethane mixture, instead of the use of ground glass fibers, provides a 25% reduction in the rate of temperature rise at the beginning of the reaction. The sandwich composite elements are preferably composed of from 3 to 5 layers, where solid and foam layers alternate, and these are produced via layer-by-layer application to a substrate, preferably by spraying. The use of glassfiber strands or woven glassfiber fabrics as reinforcing elements and/or anchoring elements is moreover disclosed, where the glassfiber strands or woven glassfiber fabrics are placed onto a layer which has not yet completed its reaction, and are enclosed into the sandwich composite element via subsequent application of a further layer. The sandwich composite elements can only be produced batchwise on substrates which serve merely for shaping and which are removed after hardening, and this process cannot therefore be carried out continuously. Since the glass fiber strands or woven glassfiber fabrics are arranged between a plurality of polyurethane layers, these merely provide a favorable effect on the mechanical properties of the sandwich structure, and no improvement of fire-protection properties is achieved. In view of the ever-more-stringent requirements placed upon sandwich composite elements in respect of their ability to resist fire, of optimized smoke performance, of efficient thermal insulation, and of high surface quality of the outer layers, there is a need for an improved, cost-effective production process that takes account of the abovementioned properties. The processes indicated in the prior art mentioned, most of which are batch processes, are unsuitable for achieving high productivity in the production of sandwich composite elements which at the same time exhibit advantageous fire performance.

### DISCLOSURE OF THE INVENTION

It is therefore an object of the present invention to provide a high-productivity process for the continuous production of sandwich composite elements which exhibit advantageous fire-protection performance.

Said object is achieved on the basis of a process for the continuous production of sandwich composite elements in accordance with the known features of claim 1 and in accordance with the known features of claim 12 in conjunction with the respective characterizing features. Advantageous embodiments of the invention are provided by the respective dependent claims.

The invention provides, in order to achieve the object, a process for the continuous production of sandwich composite elements with a lower outer layer, an upper outer layer, and a rigid polyurethane foam core introduced between the outer layers, where a twin-belt transport system has been provided with a lower transport belt and with an upper transport belt, and where the lower outer layer and the upper outer layer are continuously introduced between the transport belts. At least one glassfiber mat here moreover is introduced continuously between the outer layers, and is arranged adjacently to the inner side of at least one of the outer layers, where in order to form the rigid polyurethane foam core, a reaction mixture that subsequently foams is applied to at least one inner side of the outer layers and/or to the glass fiber mat.

The invention utilizes the favorable properties of a glassfiber mat in order to improve the fire-protection performance of sandwich composite elements. At the same time, an advantageous process is utilized for the production of the sandwich composite elements by means of a twin-belt transport system. The improved fire-protection properties of the sandwich composite elements are in particular achieved by arranging the glassfiber mat onto the inner side of the lower outer layer and/or of the upper outer layer. In SBI fire tests it was found that smoke generation can be markedly reduced by arrangement of a glassfiber mat on at least one inner side of the outer layers, and the TSP₆₀₀ test (Total Smoke Production) gives a value which is only about 100/m² (SBI test in accordance with DIN EN 13823 and fire-resistance test in accordance with DIN 1364 1 and 2). The reason is found in the melting behavior of a glassfiber mat on exposure to heat, where this produces crosslinking of the fibrous glass material, and the material of the rigid polyurethane foam core is shielded from direct flame exposure because the high-viscosity glass melt protects the rigid foam core. In particular, it was found that cracking in the rigid foam core is prevented or at least retarded in such a way that passage of fire through a sandwich composite element with a glassfiber mat introduced in the invention, during continuous exposure to flame, is prevented or at least greatly retarded.

Various advantages embodiments of the process and in particular of the arrangement of the glassfiber mat on at least one inner side of the outer layers are indicated hereinafter.

According to a first possible embodiment, in order to form the rigid polyurethane foam core, the foaming reaction mixture can be applied to the inner side of the lower outer layer, preferably by means of at least one rake applicator. The use of a rake applicator is mentioned here merely by way of example, and it is also possible to apply the foaming reaction mixture by other methods, for example by way of a mixing head, a distributor head having fluid connection to the mixing head and a number of hoses, arranged onto the distributor head, from which the reaction mixture can emerge and in particular can encounter the outer layer at points equidistant from one another. It is likewise possible to use rake applicators that oscillate perpendicularly to the direction of production, or stationary rake applicators.

At the same time a glassfiber mat can be conducted between the outer layers adjacently to the inner side of the opposite upper outer layer. If the foaming of the reaction mixture begins from the lower outer layer, the glassfiber mat can be forced against the inner side of the upper outer layer by the rise of the foaming reaction mixture, and can be saturated by the reaction mixture. The glassfiber mat can thus be adhesively bonded to the inner side of the upper outer layer by foaming reaction mixture. At the same time and/or subsequently, the foaming reaction mixture cures to give the rigid polyurethane foam core. This hardening takes place while passage through the twin-belt transport system is still continuing. Said system functions on the one hand to transport the outer layers and the glassfiber mat, in that these are entrained between the transport belts, and moreover the distance between the transport belts defines the thickness of the sandwich composite elements, which leave the twin-belt transport system in a continuous strand and then can be cut into individual elements by a separation system. The velocity with which the glassfiber mat enters the transport belts is preferably the same as that of the lower outer layer and the upper outer layer. In particular, the glassfiber mat is entrained by the progressive entrainment of the outer layers and by the bonding to the foaming and hardening reaction mixture.

According to another possible embodiment for the formation of the sandwich composite elements of the invention, the glassfiber mat can alternatively be conducted between the outer layers adjacently to the inner side of the lower outer layer, or a further glassfiber mat in addition to the glassfiber mat on the inner side of the upper outer layer can be thus conducted. In that case, the foaming reaction mixture is then not applied directly to the inner side of the lower outer layer, and while the foaming reaction mixture is still liquid it can first be applied via the rake applicator to the glassfiber mat, and the reaction mixture can then foam; the glassfiber mat is thus also forced against the lower outer layer, and bonds adhesively thereto. The process of the invention can therefore produce sandwich composite elements which have a glassfiber mat respectively either only on the inner side of the upper outer layer, only on the inner side of the tower outer layer, or on the inner side of the lower outer layer and on the inner side of the lower outer layer.

The glass fiber mat has to comply with certain criteria in order to avoid separation of the glassfiber mat from the inner side of the outer layer, and a particular situation that has to be avoided is that the foaming reaction mixture merely saturates the glassfiber mat and does not force it against the inner side of the outer layer. Once the foaming motion of the reaction mixture has ended, the arrangement ideally has the glassfiber mat as close as possible to the inner side of the outer layer and completely surrounded by and, respectively, saturated by the reaction mixture. By way of example, the glassfiber mat can have a given thickness, and the resultant distance between the glassfiber mat and the inner side of the outer layer can preferably be at most the thickness of the mat, and particularly preferably at most half of the thickness of the mat of the outer layer. The glassfiber mat used can be any continuous glassfiber sheet, and it has proven advantageous that glassfiber mats used are woven glass-filament fabric, glassfiber nonwoven, textile glassfiber mats, textile glass-sandwich mats, and/or woven-fiber-reinforced glass mats.

The glassfiber mats can in particular have a weight per unit area of from 100 to 800 g/m², preferably from 150 g/m² to 300 g/m², with preference from 200 g/m² to 250 g/m², and with particular preference 225 g/m². Glassfiber mats with specifications of these types behave, with regard to the foaming reaction mixture, as a type of foam barrier, where the material of the glassfiber mat is nevertheless saturated by the foaming reaction mixture, in order to permit adhesive bonding of the rigid polyurethane foam core to the inner side of the outer layer.

It is also advantageous to use glassfiber mats which have a softening point and/or a melting point of at least 800° C. and preferably of at least 1000° C. It is therefore possible that the nature of the glassfiber mats is such that when they are exposed to heat they develop no perforations caused by fire, and the glass material form a barrier sheet providing protection from external flame. Even in the event of exposure to severe heat, therefore, the rigid polyurethane foam core has no direct exposure to the flame.

In accordance with another advantageous embodiment, the glassfiber mat can be unwound from a roll of material and, with pretensioning, be conducted in continuous direction between the outer layers. The pretensioning can achieve contact between the glassfiber mat and the inner side of the lower outer layer or the inner side of the upper outer layer, and in particular the contact between the glassfiber mat and the respective inner side can be ensured even before contact of the glassfiber mat with the foaming reaction mixture.

Sandwich composite elements exhibit particularly advantageous fire-protection performance when the outer layers are provided from a metal web, in particular made of a metal material from the group of the stainless steels or other steels, or from an aluminum material; it is also possible that the outer layers are provided from a plastics web, which in particular has a coating, and this plastics material can likewise be selected to exhibit a particularly high level of protective action during exposure to flame.

A further advantage is achieved when the transport velocity of the twin-belt transport system is selected to have a value at which the glassfiber mat bonds adhesively to the outer layer during passage between the transport belts. The adhesive bonding of the glassfiber mat on the inner side of the outer layer should, like the hardening of the foaming reaction mixture to give the rigid polyurethane foam core, take place at a juncture at which the location of the outer layers is still between the transport belts of the twin-belt transport system, otherwise it is not possible to ensure the desired layer structure in the corresponding composite and the desired thickness of the composite element.

The foaming reaction mixture can be composed at least of the combined mixture components isocyanate and polyol, where the rigid polyurethane foam core comprises a rigid PUR foam material or a rigid PIR foam material, and where flame retardants, in particular bromine- and chlorine-containing polyols or phosphorus compounds, such as esters of orthophosphoric acid and of metaphosphoric acid, in particular comprising halogen, can have been added to the reaction mixture.

The foaming reaction mixture can be composed at least of the components polyol and isocyanate. Blowing agents added to the foaming reaction mixture made of the isocyanate component and of the polyol component can be hydrocarbons, e.g. the isomers of pentane or fluorocarbons, e.g. HFC 245fa (1,1,1,3,3-pentafluoropropane), HFC 365mfc (1,1,1,3,3-pentafluorobutane), or a mixture of these with HFC 227ea (heptafluoropropane). It is also possible to combine various classes of blowing agent. Co-blowing agents added to the foaming reaction mixture made of the isocyanate component and of the polyol component can be water and/or formic acid, or other organic carboxylic acids.

Flame retardants can have been added to the foaming PUR-PIR reaction mixture, the preferred quantity of these being from 5 to 35% by mass, based on the total mass of polyol-component compounds having hydrogen atoms reactive toward isocyanate groups. The flame retardants can by way of example be bromine- and chlorine-containing polyols or phosphorus compounds, such as the esters of orthophosphoric acid and of metaphosphoric acid, which likewise can comprise halogen. Flame retardants that are liquid at room temperature can preferably be selected.

Catalysts can have been added to the foaming reaction mixture made of the isocyanate component and of the polyol component. Examples of catalysts can be: triethylenediamine, N,N-dimethylcyclohexylamine, tetramethylenediamine, 1-methyl-4-dimethylaminoethylpiperazine, triethylamine, tributylamine, dimethylbenzylamine, N,N′,N″-tris(dimethylaminopropyl)hexahydrotriazine, dimethylaminopropylformamide, N,N,N′,N′-tetramethylethylenediamine, N,N,N′,N′-tetramethylbutanediamine, tetramethylhexanediamine, pentamethyldiethylenetriamine, tetramethyldiaminoethyl ether, dimethylpiperazine, 1,2-dimethylimidazole, 1-azabicyclo[3.3.0]octane, bis(dimethylaminopropyl)urea, N-methyl-morpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, tin(II) acetate, tin(II) octoate, tin(II) ethylhexoate, tin(II) laurate, dibutyltin diacetate, dibutyltin dilaurate, dibutyltin maleate, dioctyltin diacetate, tris(N,N-dimethylaminopropyl)-s-hexahydrotriazine, tetramethylammonium hydroxide, sodium acetate, sodium octoate, potassium acetate, potassium octoate, sodium hydroxide, or a mixture of these catalysts.

It is moreover possible to add foam stabilizers to the foaming reaction mixture made of the isocyanate component and of the polyol component, preference being given to polyether siloxanes. The structure of these compounds can have a copolymer of ethylene oxide and propylene oxide bonded to a polydimethylsiloxane moiety.

Auxiliaries and additives, catalysts, and the like can be introduced into the foaming reaction mixture prior to or during the mixing of the polyol components and isocyanate components.

The object of the present invention is further achieved via a sandwich composite element which is produced by a process of the type described above and which has a lower outer layer, an upper outer layer, and a rigid polyurethane foam core introduced between the outer layers, where there is a glassfiber mat arranged adjacently to at least one inner side of the outer layers.

### PREFERRED EMBODIMENTS OF THE INVENTION

Further measures that improve the invention are described in detail hereinafter together with the description of preferred embodiments of the invention, with reference to the figures.

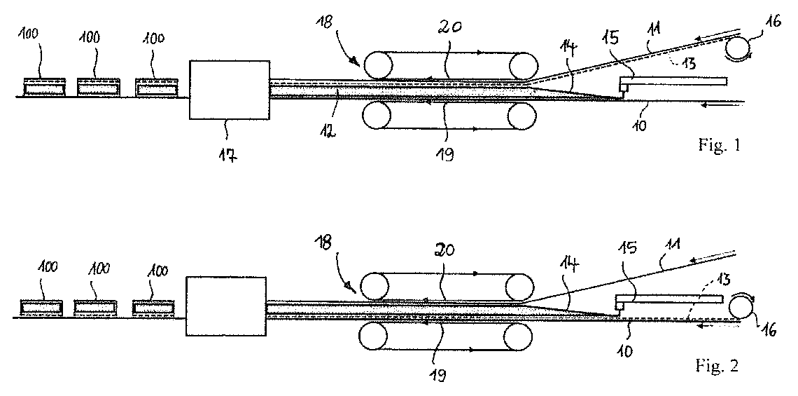

FIG. 1 is a diagram of a system for the operation of a process for the production of a sandwich composite element in accordance with a first embodiment of the present invention, where a glassfiber mat is arranged on the inner side of the upper outer layer,

FIG. 2 shows the embodiment in accordance with FIG. 1, where a glassfiber mat is arranged on the inner side of the lower outer layer,

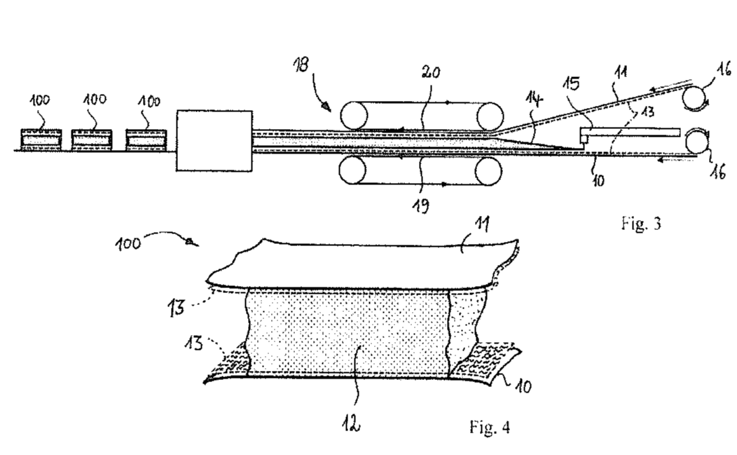

FIG. 3 shows the embodiment in accordance with FIG. 1 or FIG. 2, where a glassfiber mat is arranged respectively on the inner side of the lower outer layer and on the inner side of the upper outer layer, and

FIG. 4 is a diagram of a sandwich composite element with glassfiber mats introduced by way of example on each of the inner sides of the outer layers.

FIG. 1 is a diagram of a system for the operation of a process which serves for the production of sandwich composite elements 100 in accordance with a first embodiment of the invention. The process is operated with an apparatus which consists essentially of a twin-belt transport system 18. The twin-belt transport system 18 has a lower transport belt 19 and an upper transport belt 20, and the transport belts 19 and 20 rotate in the direction indicated by the arrow with in each case identical velocity. A gap extends between the transport belts 19 and 20, and a lower outer layer 10 and an upper outer layer 11 are entrained into the gap. A glassfiber mat 13 is moreover unwound from a roll 16 of material and entrained between the transport belts 19 and 20 in the direction indicated by the arrow, with the upper outer layer 11. The glassfiber mat 13 here is maintained under tension in such a way that it is in contact with the inner side of the upper outer layer 11. A rake applicator 15 is moreover shown, and is used to apply a foaming reaction mixture 14 to the inner side of the lower outer layer 10. The lower outer layer 10, the upper outer layer 11, and the glassfiber mat 13 are introduced with in each case identical velocity into the twin-belt transport system 18, and the foaming reaction mixture 14 here is likewise introduced concomitantly with the lower outer layer 10 into the twin-belt transport system 18.

The foaming of the reaction mixture 14 has brought it into contact with the glassfiber mat 13, which is saturated thereby. The glassfiber mat 13 is forced here against the inner side of the upper outer layer 11, and bonds adhesively thereto. By virtue of appropriate specification of the material of the glassfiber mat 13, the saturation of the glassfiber mat 13 takes place in a manner such that the foaming reaction mixture 14 forces the glassfiber mat 13 against the inner side of the upper outer layer but, despite the presence of the glassfiber mat, the foam and the outer layer can form an adhesive bond. During the passage of the outer layers 10 and 11, and of the reaction mixture 14, through the twin-belt transport system 18 the reaction mixture 14 hardens after foaming and, after bonding to the material of the glassfiber mat 13, to give a rigid polyurethane foam core 12. The rigid foam core 12 can be composed of a rigid PUR foam or of a rigid PIR foam. Once the sandwich composite material in the form of strand has emerged from the twin-belt transport system 18, this is by way of example introduced into a separation system 17 in order to produce individual sandwich composite elements 100 via appropriate cutting-to-length.

FIG. 2 shows another embodiment for the production of the sandwich composite element 100, and the lower outer layer 10 and the upper outer layer 11 are entrained in the same way into the twin-belt transport system 18 with the lower transport belt 19 and the upper transport belt 20. The embodiment shows the arrangement of a glassfiber mat 13 on the inner side of the lower outer layer 10, where the glassfiber mat 13 is unwound from a roll 16 of material with maintenance of pretensioning in a continuous direction. The glassfiber mat 13 is thus kept in contact with the inner side of the lower outer layer 10 by the rake applicator 15 prior to application of the reaction mixture 14.

In accordance with the embodiment shown, the foaming reaction mixture 14 is applied via the rake applicator 15 to the glassfiber mat 13, and the condition of the reaction mixture 14 here on emerging from the rake applicator 15 is in essence liquid. The initially liquid reaction mixture 14 that forms the foam saturates the glassfiber mat 13 here, and the foam bonds adhesively with the glassfiber mat on the inner side of the lower outer layer. The reaction mixture 14 can then foam, and can also encounter the inner side of the upper outer layer 11.

FIG. 3 finally shows an embodiment with two glassfiber mats 13 introduced. A first glassfiber mat 13 is unwound from a first roll 16 of material and conducted onto the inner side of the lower outer layer 10. In the same way another glassfiber mat 13 is unwound from another roll 16 of material and conducted onto the inner side of the upper outer layer 11. Both outer layers 10 and 11 are introduced into the twin-belt transport system 18 between the lower transport belt 19 and the upper transport belt 20, and the reaction mixture 14, still liquid, is applied via the rake applicator 15 to the lower glassfiber mat 13. This firstly saturates the glassfiber mat 13 and bonds it adhesively to the inner side of the lower outer layer 10. By virtue of the simultaneous and/or subsequent foaming of the reaction mixture in the direction toward the upper outer layer 11, the reaction mixture 14 encounters the upper glassfiber mat 13 and likewise saturates this. By virtue of the reaction mixture 14, the glassfiber mat 13 can then bond adhesively to the inner side of the upper outer layer 11. The result is provision of sandwich composite elements 100 which have respectively a glassfiber mat 13 adjacently to the inner side of each of the two outer layers 10 and 11. FIG. 4 shows an example of this type of sandwich composite element 100.

FIG. 4 is a diagram of a perspective view of an embodiment of a sandwich composite element 100. There is a rigid polyurethane foam core 12 located between the lower outer layer 10 and the upper outer layer 11, and merely by way of example here the outer layers 10 and 11 overlap the rigid polyurethane foam core 12 at the sides. By way of example, a glassfiber mat 13 is shown both on the inner side of the lower outer layer 10 and on the inner side of the upper outer layer 11, thus forming the sandwich composite element 100 of the invention. The locations of the glassfiber mats 13 are immediately adjacent to the respective inner side of the outer layer 10 and 11, but the glassfiber mats 13 here have not prevented direct contact of the inner sides with the rigid polyurethane foam core 12. In particular, the arrangement of the glassfiber mats 13 does not prevent adhesive bonding of the foaming reaction mixture 14 to the inner sides of the outer layers 10 and 11, even though the arrangement has the glassfiber mats 13 directly in the region of bonding between the rigid foam core 12 and the outer layers 10 and 11. The embodiment shown of the sandwich composite element 100 can also have the glassfiber mat 13 shown only on the inner side of the lower outer layer 10 or only on the inner side of the upper outer layer 11.

Embodiments of the invention are not restricted to the preferred embodiments provided above: it is possible to conceive of a number of variants which also utilize the solution described in embodiments of fundamentally different types. All of the features and/or advantages apparent from the claims, from the description, or from the drawings, inclusive of design details and spatial arrangements, can be significant to the invention either per se or else in a very wide variety of combinations.

### KEY

100 Sandwich composite element
10 Lower outer layer
11 Upper outer layer
12 Rigid polyurethane foam core
13 Glass fiber mat
14 Foaming reaction mixture
15 Rake applicator
16 Roll of material
17 Separation system
18 Twin-belt transport system
19 Lower transport belt
20 Upper transport belt

What is claimed is:

1. A process for the continuous production of sandwich composite elements (100) with a lower outer layer (10), an upper outer layer (11), and a rigid polyurethane foam core (12) introduced between the outer layers (10, 11), where
a twin-belt transport system (18) has been provided with a lower transport belt (19) and with an upper transport belt (20), and where
the lower outer layer (10) and the upper outer layer (11) are continuously introduced between the transport belts (19, 20), where
at least one glassfiber mat (13) is introduced continuously between the outer layers (10, 11), and is arranged adjacently to the inner side of at least one of the outer layers (10, 11), and where
in order to form the rigid polyurethane foam core (12), a reaction mixture (14) that subsequently foams is applied to at least one inner side of the outer layers (10, 11) and/or to the glass fiber mat (13).

2. The process as claimed in claim 1, characterized in that, in order to form the rigid polyurethane foam core (12), the foaming reaction mixture (14) is applied to the inner side of the lower outer layer (10) by means of at least one rake applicator (15) or by way of a mixing head, or a distributor head having fluid connection to the mixing head, or a number of hoses arranged onto the distributor head.

3. The process as claimed in claim 1 or 2, characterized in that a glassfiber mat (13) is conducted between the outer layers (10, 11) adjacently to the inner side of the upper outer layer (11).

4. The process as claimed in any of claims 1 to 3, characterized in that the glassfiber mat (13) is forced against the inner side of the upper outer layer (11) by the rise of the foaming reaction mixture (14), and is saturated by the foaming reaction mixture (14).

5. The process as claimed in any of the preceding claims, characterized in that the glassfiber mat (13) is adhesively bonded to the inner side of the upper outer layer (11) by the rise of the foaming reaction mixture (14).

6. The process as claimed in any of the preceding claims, characterized in that the glassfiber mat (13) is alternatively or additionally conducted between the outer layers (10, 11) adjacently to the inner side of the lower outer layer (10), where the foaming reaction mixture (14) is applied to the glass fiber mat (13).

7. The process as claimed in any of the preceding claims, characterized in that the glassfiber mat (13) is a continuous glassfiber sheet and comprises a woven glass-filament fabric, a glassfiber nonwoven, a textile glassfiber mat, a textile glass-sandwich mat, and/or a woven-fabric-reinforced glass mat, and in particular has a weight per unit area of from 100 to 800 g/m², preferably from 150 g/m² to 300 g/m², with preference from 200 g/m² to 250 g/m², and with particular preference 225 g/m², and/or in particular has a softening point of at least 800° C. and preferably of at least 1000° C.

8. The process as claimed in any of the preceding claims, characterized in that the glassfiber mat (13) is unwound from a roll (16) of material and, with pretensioning, is conducted in continuous direction between the outer layers (10, 11), where the glassfiber mat (13) is preferably, by virtue of the pretensioning, in contact with the inner side of the lower outer layer (10) or with the inner side of the upper outer layer (11), in particular before the glassfiber mat (13) comes into contact with the foaming reaction mixture (14).

9. The process as claimed in any of the preceding claims, characterized in that the outer layers (10, 11) are provided from a metal web, in particular made of a metal material from the group of the stainless steels or other steels, or from an aluminum material, or in that the outer layers (10, 11) are provided from a plastics web which in particular has a coating.

10. The process as claimed in any of the preceding claims, characterized in that the foaming reaction mixture (14) is composed at least of the combined mixture components isocyanate and polyol, where the rigid polyurethane foam core (12) comprises a rigid PUR foam material and/or a rigid PIR foam material, and where flame retardants, in particular bromine- and chlorine-containing polyols or phosphorus compounds, such as esters of orthophosphoric acid and of metaphosphoric acid, in particular comprising halogen, have been added to the reaction mixture (14).

11. The process as claimed in any of the preceding claims, characterized in that the transport velocity or the twin-belt transport system has a value such that when the foaming reaction mixture (14) forms a foam it bonds adhesively, with the glassfiber mat (13), to the outer layer (10, 11) during passage between the transport belts (19, 20).

12. A sandwich composite element (100) produced by a process as claimed in any of claims 1 to 11 with a lower outer layer (10), an upper outer layer (11), and a rigid polyurethane foam core (12) introduced between the outer layers (10, 11), where there is a glassfiber mat (13) arranged adjacently to at least one inner side of the outer layers (10, 11).
